(19) United States
(12) Patent Application Publication
(10) Pub. No.: US 2016/0313958 A1
(43) Pub. Date: Oct. 27, 2016

(54) CROSS-PLATFORM COMMAND EXTENSIBILITY

(71) Applicant: MICROSOFT TECHNOLOGY LICENSING, LLC, Redmond, WA (US)

(72) Inventors: Humberto Lezama Guadarrama, Redmond, WA (US); Andrew Salamatov, Seattle, WA (US); Ester Wamwitha Maina, Redmond, WA (US); Bryan Reich, Snoqualmie, WA (US); Alin Flaidar, Redmond, WA (US); Robert Gavrila, Redmond, WA (US); Rolando Jimenez Salgado, Sammamish, WA (US); Pretish Abraham, Redmond, WA (US); Timothy Wan, Redmond, WA (US); Philip Yue-Leung Chan, Redmond, WA (US); Russell Palmer, Redmond, WA (US); Angela So, Redmond, WA (US)

(21) Appl. No.: 14/839,942

(22) Filed: Aug. 29, 2015

Related U.S. Application Data
(60) Provisional application No. 62/153,423, filed on Apr. 27, 2015.

(51) Int. Cl. G06F 3/14; G06F 3/0482; H04L 12/24

(52) U.S. Cl. CPC G06F 3/1407; H04L 41/22; G06F 3/0482

(57) ABSTRACT

An abstraction for one or more commands associated with a client application may be received upon deployment of a host application. The abstraction may be an extension with a same package and code such that the extension is enabled across a variety of platforms, host applications, and devices. For example, the extension may be displayed through a user interface of the host application based on definitions contained within the abstraction such that the extension is compatible with a platform and device on which the host application is deployed. The commands may be translated into graphical control elements, and displayed in conjunction with the extension based on the definitions. Upon invocation of one or more of the commands, an action may be performed based on the definitions enabling the client application to interact with content being created, edited, and/or viewed in the host application in an appropriate context.

### CROSS-REFERENCE TO RELATED APPLICATION

This application is a non-provisional under 35 U.S.C §119(e) of co-Pending U.S. Provisional Application No. 62/153.423 filed on Apr. 27, 2015. The U.S. Provisional Application is herein incorporated by reference in its entirety.

### BACKGROUND

A user may interact with a variety of devices throughout the day, such as a smart phone, a tablet, a laptop, and/or a desktop computer, Each device may be associated with a different platform for executing a productivity suite and/or various client applications. Thus, it may be convenient to extend a user interface of a host application, such as a productivity suite application, with multiple platform-specific implementations, such that the client applications are enabled to interact with content being created, edited, and or viewed in the host application seamlessly as the user switches devices throughout the day.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to implementation of cross-platform command extensibility. In response to a deployment of a host application, the host application may receive an abstraction for one or more commands associated with a client application, where the abstraction includes one or more definitions, and is an extension with a same package and code such that the extension is enabled across a plurality of platforms, devices, and applications. The extension may be displayed through a user interface of the host application based on the definitions, and the commands may be displayed in conjunction with the extension. In response to detecting an invocation of at least one of the commands through the user interface, an action may be performed based on the definitions.

These and other features and advantages will be apparent from a reading, of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where cross-platform command extensibility may be implemented;

FIG. 2 includes a conceptual diagram illustrating a process to implement cross-platform command extensibility;

FIG. 3 illustrates an example architecture to implement cross-platform command extensibility;

FIG. 4 illustrates example configurations of an extension displayed through a host application user interface;

FIG. 5 is a networked environment, where a system according to embodiments may be implemented;

FIG. 6 is a block diagram of an example general purpose computing device, which may be used to implement cross-platform command extensibility; and

FIG. 7 illustrates a logic now diagram of a method to implement cross-platform command extensibility, according to embodiments.

### DETAILED DESCRIPTION

As briefly described above, implementation of cross-platform command extensibility may enable extensions for one or more commands associated with a client application to he displayed on user interface surfaces of a host application deployed on a variety of devices across multiple platforms. For example, upon deployment of the host application, an abstraction may be received for the commands associated with the client application. The abstraction may be received from a service provider, such as a software developer associated with the client application or host application, where the abstraction may be created using a manifest template or one or more application programming interfaces (APIs), for example. The abstraction may include one or more definitions, and may be a single extension with a same package and code such that the extension is enabled across a plurality of platforms, devices, and applications, including a platform and device on which the host application is deployed. The extension may be displayed through the user interface of the host application, and the commands may he translated into graphical control elements and displayed in conjunction with the extension based on the definitions. In response to detecting an invocation of at least one of the commands through the user interface, an action, such as launching a task pane, menu, and/or dialog of the client application through the user interface of the host application, may be performed based on the definitions.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “server” generally refers to a computing device executing one or more software programs typically in a networked environment. However, a server may also be implemented as a virtual server (software programs) executed on one or more computing devices viewed as a server on the network. More detail on these technologies and example operations is provided below.

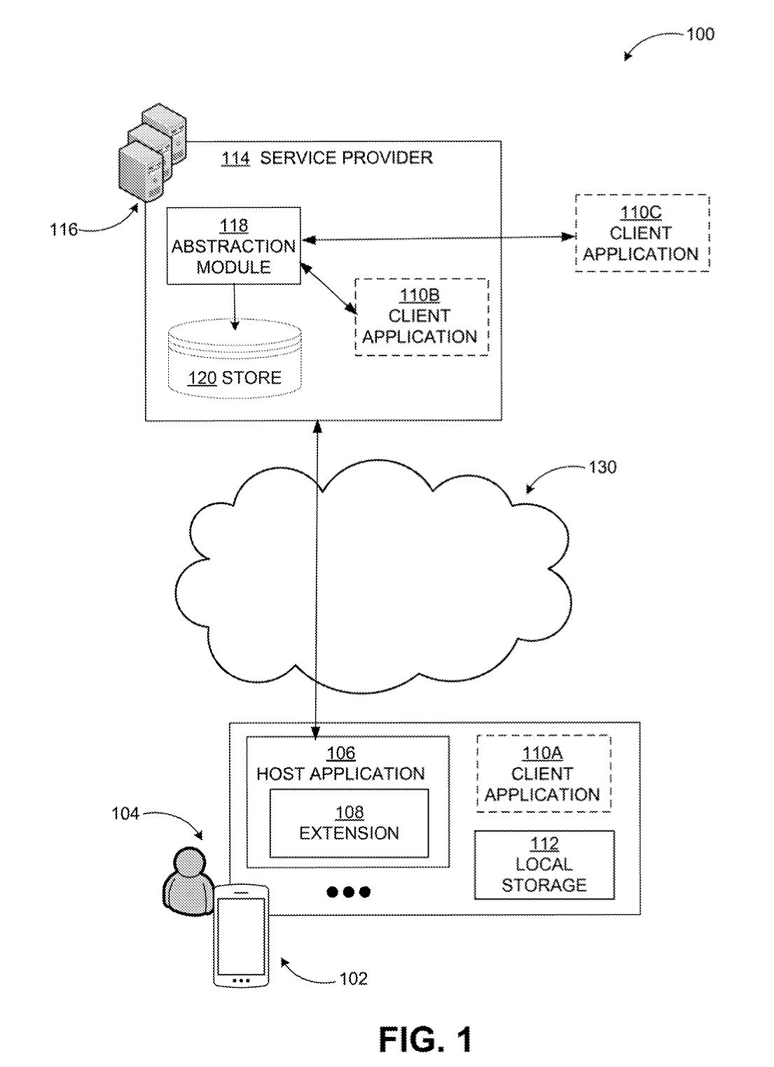

FIG. 1 includes an example network environment where cross-platform command extensibility may be implemented. As illustrated in diagram 100, a device 102 associated with a user 104 may include a variety of applications, such as a host application 106 and a client application 110A, and local storage 112 configured to store data associated with the variety of applications. The device 102 may include a desktop computer, a laptop computer, a tablet computer, a vehicle mount computer, a smart phone, or a wearable computing device, among other similar devices. The host application 106 may be a thin a web browser) or a thick (e.g., a locally installed application) version of the host application 106, whereas the client application 110A may be a locally installed application. In some examples, the host application 106 may be associated with a productivity suite, where the host application 106 is one of a word-processing application, a communication application, a spreadsheet application, a presentation application, and a notebook application, among other productivity suite applications. A service provider 114 hosted by one or more servers 116 may be a software developer associated with the client application 110A, a software developer associated with the host application 106 and/or a third party service. The service provider 114 may desire to enable an extension for commands associated with the client application 110A on a user interface of the host application 106, when the host application 106 is deployed on a variety of devices, including device 102, across multiple platforms.

In an example embodiment, the service provider 114 may employ an abstraction module 118 to create an abstraction for one or more commands associated with the client application 110A, in response to the local installation of the client application 110A on the device 102. If the service provider 114 is the software developer associated with the client application 110A, the abstraction module 118 may use a copy of the client application 110B stored within the servers 116 to create the abstraction. If the service provider 114 is the software developer associated with the host application 106 or the third party service, the service provider 114 may obtain permission and retrieve a copy of the client application 110C from the software developer associated with the client application 110A to create the abstraction. The abstraction module 118 may create the abstraction using a template manifest and/or one or more APIs, and store the abstraction in a data store 120 associated with the service provider 114. The abstraction may include one or more definitions and may be a single extension with a same package and code such that a variety of different platforms and devices may interpret the commands into an appropriate concrete implementation according to the platform and device the host application 106 is running on. The definition may include a target host, (e.g., the host application 106), a target device, (e.g., the device 102 on which the host application 106 was deployed), a placement of the extension on a target host user interface, one or more types of graphical control elements to represent the commands, a placement or a grouping of the commands in conjunction with the extension, an action to be performed in response to a detection of an invocation of at least one of the commands, and activation rules associated with the commands, for example.

In response to a deployment and/or execution of the host application 106 on the device 102, the service provider 114 may retrieve the abstraction from the data store 120 and provide the abstraction to the host application 106 over one or more networks 130, such as a cloud based network. Upon receipt, the host application 106 may display an extension 108 through a user interface of the host application 106 based on the definitions contained within the abstraction such that the extension 108 is compatible with the platform and device 102 on which the host application 106 is deployed and/or executed. In some embodiments, the extension 108 may lie projected as native entry points in the user interface. For example, the extension 108 may be projected on a primary commanding surface (for example, through a command bar or contextual menu), a message component command surface, and/or a backstage command surface. The commands may be translated to graphical controls elements and displayed in conjunction with the extension 108 based on the definitions.

In response to detection of a user invocation of at least one of the commands through the user interface, the host application 106 may be configured to perform an action as defined by the abstraction. For example, the host application 106 may launch a special-purpose task pane, a menu, and/or a dialog of the client application 110 through the user interface, enabling the client application 110 to interact with content being created, edited, and/or viewed in the host application 106 in an appropriate context. In other embodiments, custom code development may be triggered to handle the action. For example, sandboxed code may be developed to handle the action.

Once the extension 108 is added to the user interface of the host application 106 that is being executed on the device 102 and platform associated with the user 104, there is no need for the user 104 to make any explicit gesture for the extension 108 to be added in a same host application that is being executed on other devices and/or platforms associated with the user 104. For example, the extension 108 may roam across devices and platforms such that there is no need to individually add the extension 108 in the host application 106 as it is being deployed and/or executed on each platform or each device. If the extension 108 is determined to be no longer needed and/or wanted, the client application 110A associated with the extension 108 may be uninstalled from the device 102.

Cross-platform command extensibility, as described herein, may enable client applications to interact seamlessly with content being created, edited, and/or viewed in a host application in an appropriate context via an extension displayed through a user interface of the host application. In some examples, customization of the extension may be enabled using customization tools of the host application, further increasing interaction between the client applications and the host application. As such, cross-platform command extensibility may provide deeper user interface integration of various client applications and the host application, which may enable improved usability and thus, more efficient user interaction.

Additionally, by creating the abstraction for the commands of the client applications as a single extension with the same package and code, the extension may be enabled across a variety of platforms, host applications, and client devices. Accordingly, the extension may roam across devices and platforms such that there is no need to individually add the extension to a user interface of a host application as it is being deployed and/or executed on each platform or each device associated with the user. Thus, implementation of cross-platform command extensibility may also enable reduced processor load (and consequently increased processing speed), conservation of memory, and reduced network bandwidth usage, among other features, that may improve the efficiency and performance of the devices on which the host application is deployed.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of users, applications, platforms, and devices.

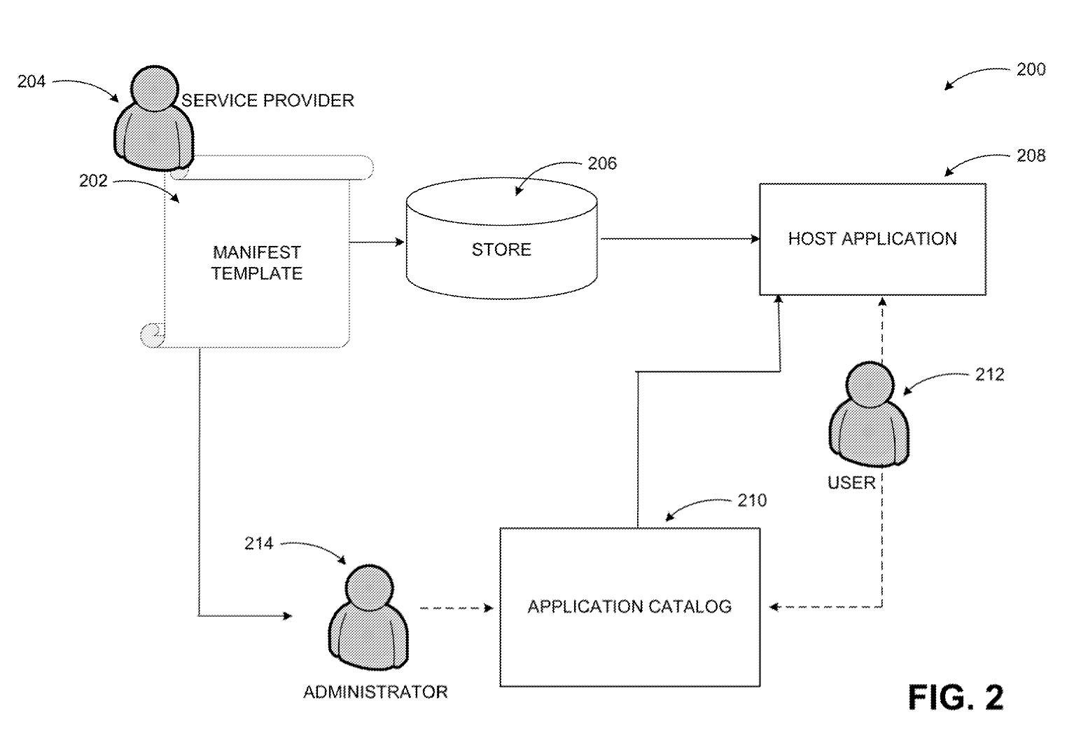

FIG. 2 includes a conceptual diagram illustrating, a process to implement cross-platform command extensibility. As shown in diagram 200, a service provider 204 may desire to enable an extension for commands associated with a client application on user interface surfaces of a host application 208 deployed on a variety of devices across multiple platforms. The service provider 204 may be a software developer associated with the client application, a software developer associated with a host application and/or a third party service, for example.

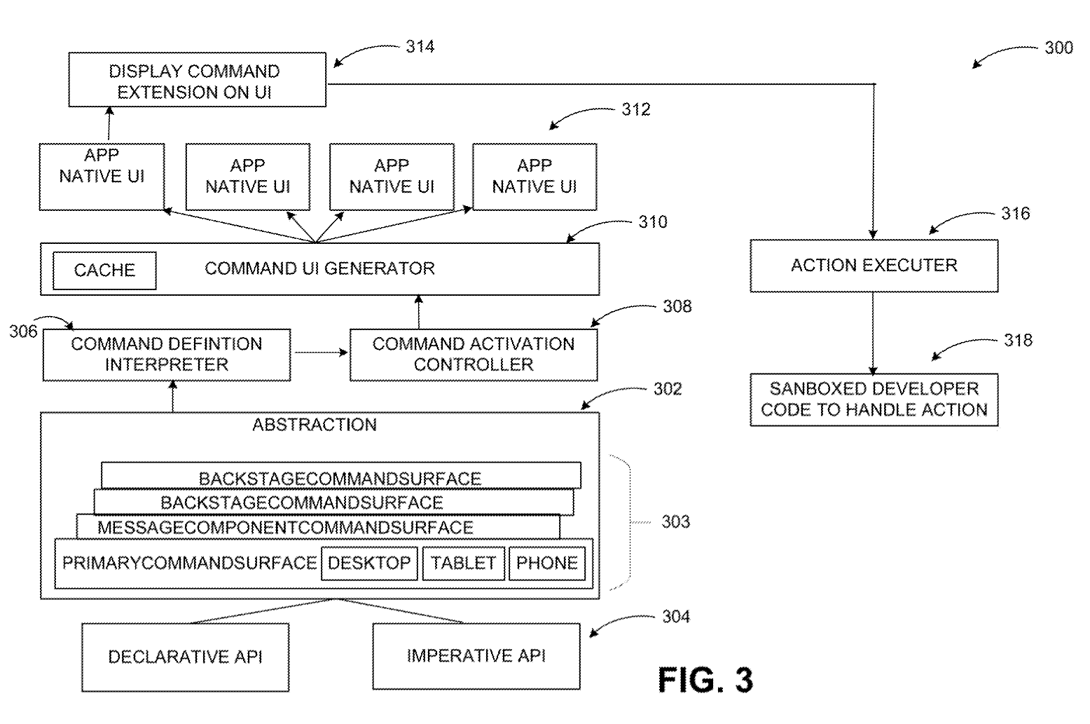

In an example embodiment, the service provider 204 may create an abstraction for one or more commands associated with the client application using a manifest template 202. In some examples, creation of the abstraction using the manifest template 202 may provide backward compatibility with down-level client applications. Alternately, the service provider 204 may create the abstraction using one or more application programming interfaces (APIs), which is discussed in conjunction with FIG. 3. The abstraction may be a single extension with a same package and code such that the extension is enabled across a plurality of platforms, devices, and host applications. The abstraction may include one or more definitions, such as a target host (e.g., the host application 208), a target device e.g., a device on which the host application 208 is deployed on), a placement of the extension on a target host user interface, one or more types of graphical control elements to represent the commands, a placement or a grouping of the commands, an action to be performed in response to a detection of an invocation of at least one of the commands, and activation rules associated with the commands, for example. The service provider 204 may store the abstraction in a repository 206, such as a data store. In some embodiments, the service provider 204 may provide the abstraction to an administrator 214.

A user 212 or the administrator 214 may deploy the host application 208 from an application catalog 210 and/or file share stored on a device associated with the user 212 or administrator 214, respectively. In response to the deployment, the abstraction may be retrieved from the repository 206, and provided to the host application 208. The host application 208 may be configured display an extension through a user interface of the host application 208 based on the definitions of the abstraction. The commands may be displayed in conjunction with the extension, where the commands may be translated into graphical control elements for display based on the definitions of the abstraction. The graphical control elements may include buttons, menus, and/or toggles, for example.

In response to the user 212 or administrator 214 activating and/or invoking one or more of the graphical control elements through the user interface of the host application 208, an action may be performed as defined by the abstraction. In one example, one of a task pane, a menu, or a dialog of the client application may be launched through the user interface of the host application such that the client application is enabled to interact with content being created, edited, and/or viewed in the host application 208 in an appropriate context based on a platform and device on which the host application 208 is deployed. In another example, development of custom developer code may be triggered to handle the action.

In an example scenario, a client application may include a command that enables a user to create a document based on a template. A service provider associated with the client application may desire to enable an extension for the command on a user interface of a word-processing application such that the client application is enabled to interact with content being created, edited, and/or viewed in the word-processing application in an appropriate context based on a platform and device on which the word-processing application is deployed.

In response to installation of the client application on a lap-top computer, the service provider may create an abstraction for the command using a manifest template, where the abstraction includes definitions, and is a single extension with a same package and same code. The definitions may include a target host, such as the word-processing application, and a target device, such as the lap-top computer. The definitions may also include a placement of the extension on the user interface of the target host, such as an existing “Home” tab on a command bar of the user interface of the word-processing application. The definitions may further include a type of graphical control element to represent the command, such as a button, and a placement of the command in conjunction with the extension. The definitions may yet further include an action to be performed in response to a detection of an invocation of the command, such as launching of a task pane of the client application, and activation rules associated with the commands, for example.

In response to a deployment of the word-processing application on the lap-top computer, the service provider may provide the abstraction to the word-processing application. The word-processing application may display the extension as a group of the existing “Home” tab on a command bar of the user interface of the word-processing application, where the command is displayed as a button in conjunction with the extension based on the definitions of the abstraction. In response to a user invoking the command/button, the word-processing, application may launch a task pane associated with the client application enabling the user to interact with the client application and the word-processing application seamlessly. For example, the user may create a document within the word-processing application using a template from the client application.

FIG. 3 illustrates an example architecture implemented for cross-platform command extensibility. As illustrated in diagram 300, an abstraction 302 for one or more commands associated with a client application may be created using one or more application programming interfaces (APIs) 304. For example, the APIs 304 may include an imperative API, and a declarative API. The abstraction 302 may include one or more definitions 303 and may be a single extension with a same package and code, such that a variety of different platforms may interpret the commands into an appropriate concrete implementation according to the platform a target host, and thus the extension is running on.

The definitions 303 may include the target host, such as a productivity suite application (e.g., a word-processing application, a presentation application, a spreadsheet application, a communication application, and a notebook application, among other examples), and a target device, such as a smart phone, a tablet, and/or a desktop. The definitions 303 may also include a type of graphical control element to represent the commands on a user interface of the target host, such as buttons, menus, and/or toggles. The definitions 303 may further include how to group the commands in conjunction with the extension on the user interface, and a location or position on the user interface to display the extension. For example, whether the extension may be displayed on a primary commanding surface (for example, through a command bar or contextual menu), a message component command surface, and/or one or more backstage command surfaces. If the extension is defined to be displayed through a command bar, the definitions may further include whether the extension may be displayed as a group on an existing tab of a command bar of the user interface, or the extension may be displayed as one or more groups on a new tab created for the command bar.

The definitions 303 may further include a command action to indicate a function to be called when one or more of the commands are invoked by a user, and implicit and/or explicit activation rules for the commands. Implicit activation rules may be derived from a type of extension or specific extension point being targeted. For example, targeting a primary commanding surface of the host application, without any further rules, implicitly indicates that the commands are meant to be ever-present. Another example of an implicit activation rule is adding commands to a “Content” extension type (embeddable object) which implicitly means that the commands are displayed whenever that object is selected. The extension travels with the document and thus the commands would travel with the document as well. Explicit activation rules provide tacit control over when to display a command, for example, display the command on documents of a certain type or matching a given characteristic. For example, show some commands in a word-processing application, when creating and/or editing invoice based documents. For further example, show commands in a communication application when a message contains a tracking number.

Upon deployment of the target host, the target host may receive the abstraction 302. The definitions 303 of the abstraction 302 may be interpreted by a command definition interpreter 306 of the target host, and the interpreted definitions may he transmitted to a command activation controller 308 of the target host configured to control activation of the commands. A command user interface generator 310 of the target host may be configured to provide the target host with a platform specific user interface 312 through which the extension is displayed 314 based on the interpreted definitions of the abstraction 302. The commands may be displayed in conjunction with the extension, where the commands may be translated into graphical control elements based on the interpreted definitions of the abstraction 302.

Upon user invocation of one of the graphical control elements representing the commands, an action executer 316 may be configured to perform an action based on the interpreted definitions of the abstraction 302 to execute the commands. For example, the action executer 316 may display a special-purpose task pane, a menu, or a dialog of the client application through the user interface of the target host, enabling the client application to interact with content being created, edited, and/or viewed in the target host in an appropriate context. In an example scenario, each graphical control element may specify a different uniform resource locator (URL) associated with the client application stored in a data store. When a user activates one of the graphical control elements, the action executer 316 may display the task pane and load the corresponding URL. In other embodiments, the action executer 316 may execute the command without any user interface involvement. For example, the action executer 316 may trigger custom developer code, such as a sandboxed code, to be developed 318 to handle the action. In some embodiments, a user may be notified if an error occurs during, execution of the commands through the user interface even if the execution of the command does not involve the user interface.

In some embodiments, the extension may be customized using customization tools of the target host. For example, an existing tab, new tab, groups within the existing or new tabs, and/or graphical control elements associated with the extension may be moved around in the command bar using the customization tools of the target host. In further embodiments, the extension and/or commands may be updated in response to detecting an update of the client application. For example, one or more additional commands may be added to the extension, one or more of the commands may be removed from the extension, and/or one or more of the commands may be updated.

Once the extension has been added to the user interface of the target host deployed on a device and/or platform associated with the user, there is no need for users to make any explicit gesture for the command extension to be added to the user interface of the target host executed on my other devices and/or platforms associated with the user. For example, if the target host detects that the command extension is not displayed through the user interface of the target host that is being executed on another device or platform, the extension may be automatically re-displayed through the target host user interface based on the definitions of the abstraction 302. In some examples, retry notifications may be provided to the users as the extension is being re-displayed. In other embodiments, the extension of the target host user interface may roam across devices and platforms such that there is no need to individually add the command extension to the target host as it is being executed on each platform or each device. If the extension is determined to be no longer needed and/or wanted the client application of which the extension is associated with may be uninstalled from the device, causing removal of the extension from display on the existing tab of the command bar, removal of the new tab in its entirety from display on the command bar, and/or removal of the extension from display on the contextual menu.

In an example scenario, a client application may include multiple commands that enables a user to find and correct common errors in documents. For example, the commands may include to find and correct consistency errors, grammar errors, and complexity errors in documents. A third party service provider may desire to enable an extension for the command on a user interface of a productivity suite application such that the client application is enabled to interact with content being created, edited, and/or viewed in the productivity suite application in an appropriate context based on a platform and device on which the productivity suite application is deployed. The productivity suite application may include a word-processing application, a communication application, a presentation application, a spreadsheet application, and a notebook application, among other examples.

In response to installation of the client application on a tablet, the service provider may create an abstraction for the commands using APIs, where the abstraction includes definitions, and is a single extension with a same package and same code such that the extension may be enabled across platforms, devices, and the various productivity suite applications. The definitions may include a target host, such as a productivity suite application, and a target device, such as the tablet. The definitions may also include as placement of the extension on the user interface of the target host, such as an existing “Review” tab on a command bar of the user interface of the productivity suite application.

The definitions may further include a type of graphical control element to represent the each command, such as buttons, and a placement of the commands in conjunction with the extension. The definitions may yet further include an action to be performed in response to a detection of an invocation of the command, such as launching of a task pane of the client application, and activation rules associated with the commands, for example.

In response to a deployment of a productivity suite application, such as a presentation application on the tablet, the service provider may provide the abstraction to the presentation application. The presentation application may display the extension as a group of the existing, “Review” tab on a command bar of the user interface of the word-processing application, where the commands are displayed as buttons in conjunction with the extension. In response to a user invoking the button corresponding to the command to find and correct consistency errors, the presentation application may launch a task pane associated with the client application enabling the user to interact with the client application and the presentation application in an appropriate context for the platform and device on which the presentation application and extension is running. For example, the client application may find and correct consistency errors within the document being viewed in the presentation application

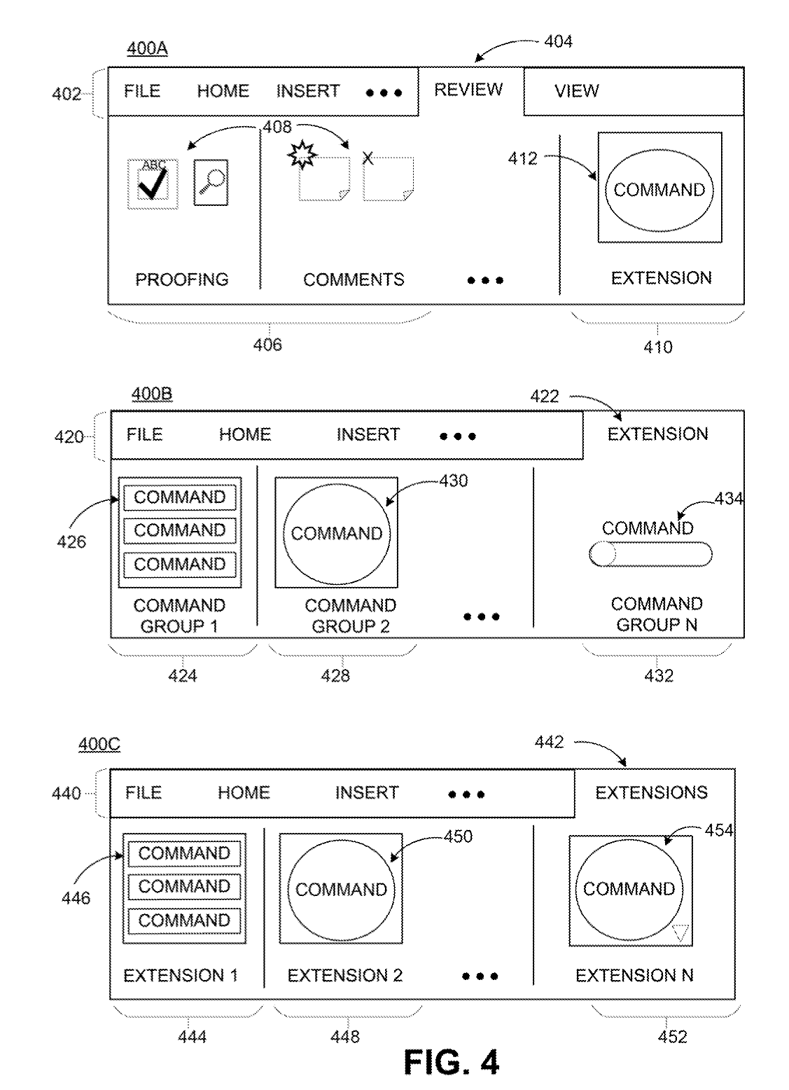

FIG. 4 illustrates example configurations of an extension displayed through a host application user interface. As previously discussed, upon deployment of a host application, an abstraction for one or more commands associated with a client application may be received by the host application from a service provider. The abstraction may include one or more definitions, and may be a single extension with a same package and code. The extension may be displayed through a user interface of the host application based on the definitions, and the commands may be translated into graphical control elements and displayed in conjunction with the extension further based on the definitions. Configurations 400A, 400B, and 400C illustrate various examples of how the extension and commands may be displayed through the user interface of the host application.

In one embodiment, as illustrated in configuration 400A, an extension associated with a client application may be displayed as a group 410 on an existing tab 404 of a command bar 402 of the host application user interface, such as a “Review” tab. A command 412 for the client application may be translated to a button for display in conjunction with the extension. The existing tab 404 may include one or more other groups 406 associated with the host application, such as proofing and comment related groups of the “Review” tab, that each comprise one or more commands 408 for the host application. In some examples, the extension may be displayed at the end of the existing tab 404 (that is, the group 410 may be displayed at a furthest right position on the existing tab 404 relative to the other groups 406), as illustrated. In other examples, the extension may be interspersed amongst commands of the host application on the existing tab 404 based on a priority of the extension (that is, the group 410 may be interspersed among the other groups 406 on the existing tab 404). The service provider may choose the existing tab 404 on which the extension is displayed by defining the existing, tab 404 within the abstraction, or the extension may be automatically assigned to the existing tab 404. If multiple other extensions are displayed within the existing tab 404, each extension, may be displayed on the existing, tab 404 in an order in which the client applications of the extensions were installed on the device.

In another embodiment, as illustrated in configuration 400B, an extension associated with a client application may be displayed as one or more command groups 424, 428, 432 on a new tab 422 created for the command bar 420 of a host application user interface. Commands 426, 430, 434 of the client application may be translated to graphical control elements, and displayed in conjunction with the extension in each of the command groups 424, 428, 432, The one or more commands 426, 430,434 within each respective command group may be related. For example, the three commands 426 within command group 424 may be associated with configuration and/or settings of the extension.

In a further embodiment, as illustrated in configuration 400C, multiple extensions, each associated with a different client application, may be displayed as groups 444, 448, 452 on a new tab 422 created for the command bar 420 of the host application user interface. One or more commands 446, 450, 454 for each client application may be displayed in conjunction with the respective groups 444, 448, 452 representing the extensions.

For each of the above-described configurations, 400A, 400B, and 400C, a textual scheme, a graphical scheme, an audio scheme, an animation scheme, a coloring scheme, a highlighting scheme, and/or a shading scheme may be employed to enhance presentation of the extension and commands on the command bar of the host application user interface. For example, the commands may be translated to graphical control elements based on the definitions of the abstraction. Example graphical control elements may include one or more buttons (e.g., commands 412, 426, 430, 446, and 450), a menu including one or more submenus and buttons (e.g., command 454), and/or a toggle (e.g., command 434), The menu may be a drop-down menu or a pop-up menu, for example. The buttons may be of variable sizes and color, and arrangement of the buttons may be based on pre-defined templates. The buttons, menu, and/or toggle may include icons, text, and/or text-based labels, where the labels may be associated with the function of the command.

In some embodiments, the size of the buttons may be automatically selected based on a configuration of a target device. For example, the size selected may be based on the dots per inch (dpi), zoom level, touch capability of a display of the target device. In some devices, such as tablets or smart phones, with smaller screen displays one size buttons may be selected, and no pre-defined templates or labels may be displayed in association with the buttons and/or tabs, This may preserve display screen space when the user is interacting with the host application to one of create, edit, and/or view content, for example.

The examples provided in FIGS. 1 through 4 are illustrated with specific devices, applications, modules, and user interface configurations. Embodiments are not limited to environments according to these examples. Cross-platform command extensibility may be implemented in environments employing fewer or additional services, devices, applications, modules, and user interface configurations. Furthermore, the example devices, applications, modules, and user interface configurations shown in FIG. 1 through 4 may be implemented in a similar manner with other values using the principles described herein.

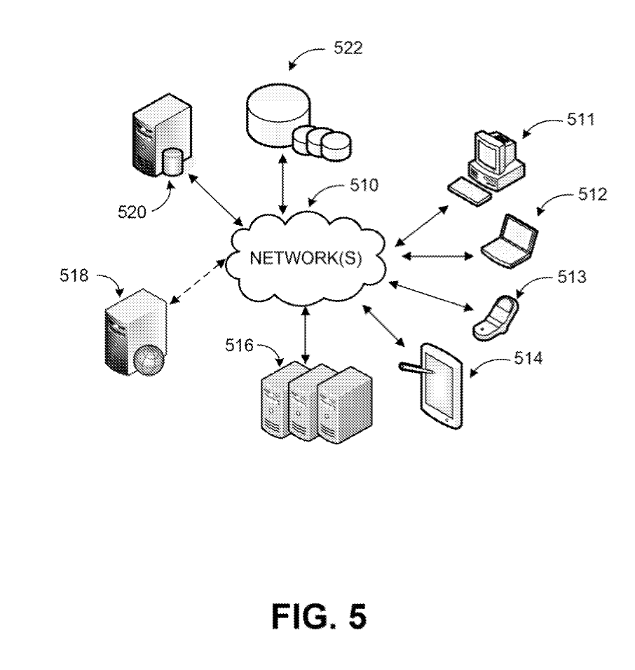

FIG. 5 is a simplified networked environment, where a system according to embodiments may be implemented. Cross-platform command extensibility may be implemented via software executed over one or more servers 516 such as a host application. The platform may communicate with client applications on individual computing devices such as a tablet 514, a smart phone 513, a laptop computer 515, or desktop computer 511 (‘client devices’) through network(s) 510.

Client applications executed on any of the client devices 511-514 may facilitate communications via application(s) executed by servers 516, or on individual server 518. An abstraction for one or more commands associated with a client application may be received by the host application in response to a deployment of the host application on one of the client device 511-514. The abstraction may include one or more definitions, and may be a single extension with a same package and code. The extension may be displayed through a user interface of the host application, and the commands may be translated into graphical control elements and displayed in conjunction with the extension based on the definitions of the abstraction. The host application may store data associated with the abstraction definitions in data store(s) 522 directly or through database server 520.

Network(s) 510 may comprise any topology of servers, clients. Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement cross-platform command extensibility. Furthermore, the networked environments discussed in FIG. 5 are for illustration purposes only. Embodiments are not limited to the example applications, modules, or processes.

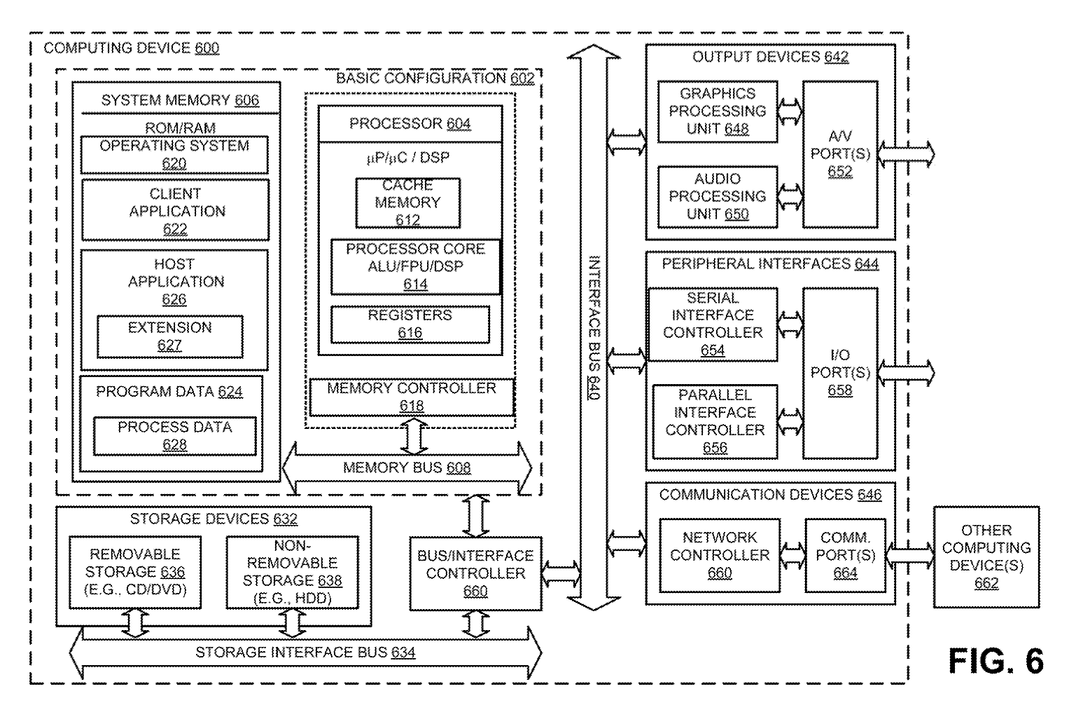

FIG. 6 and the associated discussion are intended to provide a brief, general description of a general purpose computing device, which may be used to implement cross platform command extensibility.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP) a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but, not limited to volatile memory (such as RAM), non-volatile memory (such as ROM, flash memory, etc.) or any combination thereof. The system memory 606 may include an operating system 620, a client application 622, a host application 626, and program data 624. In response to a deployment and/or execution of the host application 626 by the processor 604 of the computing, device 600, the host application 626 may receive an abstraction for one or more commands associated with the client application 622, where the abstraction includes one or more definitions and is an extension 627 with a same package and code. The host application 626 may display the extension 627 through a user interface of the host application based on the definitions, where the commands are displayed in conjunction with the extension. In response to an invocation of one or more of the commands, the host application 626 may perform an action based on the definitions. The program data 624 may include, among other data, process data 628 related to the definitions of the abstraction, etc., as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system Memory 606, the removable storage devices 636 and the non-removable storage devices 638 are examples of computer storage media. Computer storage media includes, but is not limited to RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RE), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods to implement cross-platform command extensibility. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

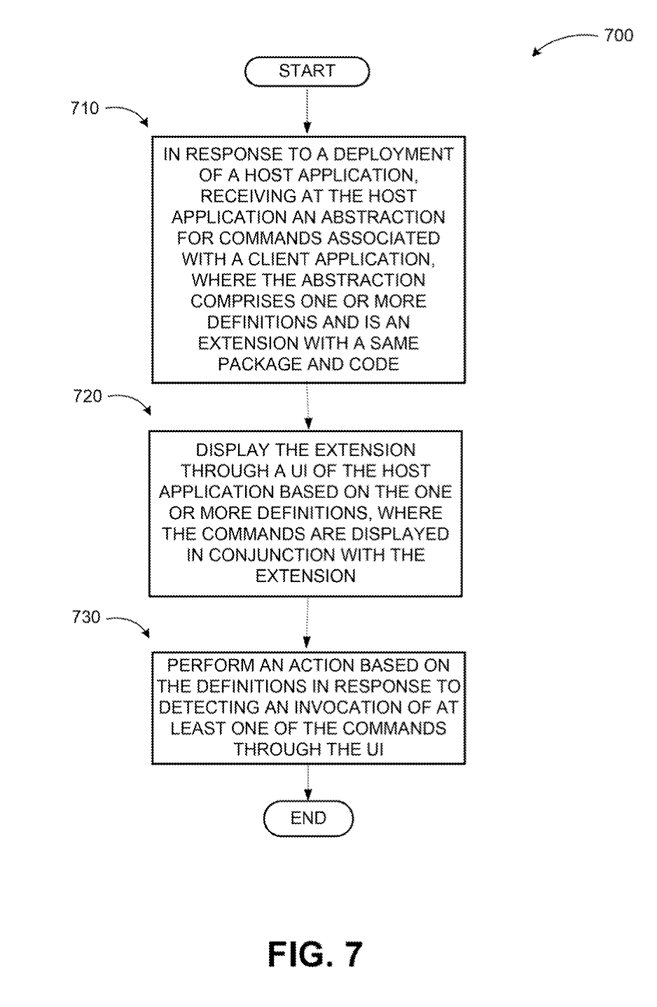

FIG. 7 illustrates a logic flow diagram for process 700 of a method to implement cross-platform command extensibility, according to embodiments. Process 700 may be implemented on a server or other system.

Process 700 begins with operation 710, where in response to a host application being deployed on a device, the host application is configured to receive an abstraction for one or more commands associated with a client application. The abstraction may be received from a service provider through a communication interface of the device, where the service provider may be configured to create the abstraction using a template manifest and/or one or more APIs. The abstraction may be a single extension with a same package and code such that the extension is enabled across a plurality of platforms, devices, and applications, including a platform and the device on which the host application is deployed. The abstraction may comprise one or more definitions, including a target host, (e.g., the host application), a target device, (e.g., the device on which the host application was deployed), a placement of the extension on the user interface, one or more types of graphical control elements to represent the commands, a placement or a grouping, of the commands, an action to be performed in response to a detection of an invocation of at least one of the commands, and activation rules associated with the commands, for example.

At operation 720, the extension may be displayed through a user interface of the host application based on the definitions such that the extension is compatible with the platform and device on which the host application is deployed. In some examples, the extension may be displayed as a group on an existing tab of a command bar of the user interface, the extension may be displayed as one or more groups on a new tab created for the command bar, and/or the extension may be displayed on a. contextual menu of the user interface. The commands may be displayed through the user interface in conjunction with the extension by translating the commands to graphical control elements, such as buttons, menus, and toggles, and placing and/or grouping the commands within the extension based on the definitions.

At operation 730, an action may be performed based on the definitions in response to a detection of an invocation of at least one of the commands through the user interface of the host application. The action may include launching a task pane, a menu, and/or a dialog associated with the client application through the user interface of the host application. The action may also include triggering development of custom developer code to handle the action.

The operations included in process 700 are for illustration purposes. Cross platform command extensibility may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, methods to implement cross-platform command extensibility are provided. An example method may include receiving at a host application an abstraction for one or more commands associated with a client application in response to a deployment, of the host application, where the abstraction comprises one or more definitions, and is an extension with a same package and code such that the extension is enabled across a plurality of platforms, devices, and applications. The example method may also include displaying the extension through a user interface of the host application based on the definitions, where the commands are displayed in conjunction with the extension, and performing an action based on the definitions in response to detecting an invocation of at least one of the commands through the user interface.

In other examples, customization of the extension may be enabled using one or more customization tools of the host application. The extension may be displayed as a group on an existing tab of a command bar on the user interface of the host application. The extension may be displayed as one or more groups on a new tab created for a command bar on the user interface of the host application. The commands may be translated to one or more graphical control elements for display based on the one or more definitions, where the graphical control elements include buttons, a menu, a drop-down menu, a selection gallery, a text input box, and/or a toggle.

In further examples, performing the action based on the one or more definitions may include launching a task pane, a menu, and/or a dialog of the client application through the user interface of the host application. Performing the action based on the one or more definitions may also include triggering development of custom developer code to perform the action. The extension may be removed from the user interface of the host application by un installing the client application from a device on which the host application is deployed, in response to detecting an update to the client application, an update to the extension may he enabled, where the update may include displaying one or more additional commands, removing at least one of the one or more commands from display, and updating the one or more commands displayed.

According to some embodiments, computing devices to implement cross-platform command extensibility are described. An example computing device may include a communication interface configured to facilitate communication between the computing device and a service provider, a memory configured to store instructions, and one or more processors coupled to the memory, and configured to execute a host application in conjunction with the instructions stored in the memory. The host application may be configured to receive an abstraction for one or more commands associated with a client application from the service provider through the communication interface, where the abstraction comprises one or more definitions, and is an extension with a same package and code such that the extension is enabled across a plurality of platforms, devices, and applications. The host application may also be configured to display the extension through a user interface of the host application based on the definitions, where the commands are displayed in conjunction with the extension, and perform an action based on the definitions in response to detecting an invocation of the commands through the user interface.

In other embodiments, the definitions include a target host, is target device, a placement of the extension on the user interface, one or more types of graphical control elements to represent the commands, a placement or a grouping of the e commands, the action to be performed in response to the detection of the invocation of the commands, and implicit and explicit activation rules associated with the commands. The service provider may be a software developer associated with the client application, a software developer associated with the host application, or a third party service. The abstraction may be created by the service provider using a manifest template or one or more application programming interfaces (APIs) in response to an installation of the client application on the computing device.

In further embodiments, the host application may be configured to display the extension as a group on an existing tab of a command bar on the user interface, display the extension as one or more groups on a new tab created for the command bar on the user interface based on the definitions, or display the extension on a contextual menu of the user interface. The host application may be further configured to display the extension as the group at a furthest right position on the existing tab relative to other groups on the existing tab of the command bar. The host application may be further configured to display the extension as the group at a position interspersed with other groups on the existing tab of the command bar based on a priority of the extension. The host application may be further configured to display another extension through the user interface of the host application, where the extension and the other extension may be displayed on the existing tab in an order in which respective client applications associated with extension and the other extension were installed on the computing device.

According to some examples, computer-readable memory devices with instructions stored thereon to implement cross-platform command extensibility are described. Example instructions may include receiving at a host application an abstraction for one or more commands associated with a client application in response to a deployment of the host application, where the abstraction comprises one or more definitions, and is an extension with a same package and code such that the extension is enabled across a plurality of platforms, devices, and applications. The example instructions may also include displaying the extension through a user interface of the host application based on the definitions, and displaying the commands in conjunction with the extension by translating the commands to one or more graphical control elements based on the definitions. The example instructions may further include performing an action based on the definitions in response to detecting a user invoke the commands through the user interface.

In other examples, in response to detecting an error while the action is being performed, the user may be notified of the error through the user interface.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to implement cross-platform command extensibility, the method comprising:
receiving at a host application an abstraction for one or more commands associated with a client application, wherein the abstraction comprises one or more definitions, and is an extension with a same package and code such that the extension is enabled across a plurality of platforms, devices, and applications;
displaying the extension through a user interface of the host application based on the one or more definitions, wherein the one or more commands are displayed in conjunction with the extension; and
in response to detecting an invocation of at least one of the one or more commands through the user interface, performing an action based on the one or more definitions.

2. The method of claim 1, further comprising:
enabling customization of the extension using one or more customization tools of the host application.

3. The method of claim 1, further comprising:
displaying the extension as a group on an existing tab of a command bar on the user interface of the host application.

4. The method of claim 1, further comprising:
displaying the extension as one or more groups on a new tab created for a command bar on the user interface of the host application.

5. The method of claim 1, translating the one or more commands to one or more graphical control elements for display based on the one or more definitions.

6. The method of claim 5, wherein the graphical control elements include one or more of buttons, a menu, a drop-down menu, a selection gallery, a text input box, and a toggle.

7. The method of claim 1, wherein performing the action based on the one or more definitions comprises launching one or more of a task pane, a menu, and a dialog of the client application through the user interface of the host application.

8. The method of claim 1, wherein performing the action based on the one or more definitions comprises triggering development of custom developer code to perform the action.

9. The method of claim 1, further comprising:
enabling the extension to be removed from the user interface of the host application by un-installing the client application from a device on which the host application is deployed.

10. The method of claim 1, further comprising:
in response to detecting an update to the client application, enabling an update to the extension, wherein the update may include displaying one or more additional commands, removing at least one of the one or more commands from display, and updating the one or more commands displayed.

11. A computing device to implement cross-platform command extensibility, the computing device comprising:
a communication interface configured to facilitate communication between the computing device and as service provider;
a memory configured to store instructions; and
one or more processors coupled to the memory, and configured to execute a host application in conjunction with the instructions stored in the memory, the host application configured to:
receive an abstraction for one or more commands associated with a client application from the service provider through the communication interface, wherein the abstraction comprises one or more definitions, and is an extension with a same package and code such that the extension is enabled across a plurality of platforms, devices, and applications;
display the extension through a user interface of the host application based on the one or more definitions, wherein the one or more commands are displayed in conjunction with the extension; and
in response to detecting an invocation of the one or more commands through the user interface, perform an action based on the one or more definitions.

12. The computing device of claim 11, wherein the one or more definitions include a target host, a target device, a placement of the extension on the user interface, one or more types of graphical control elements to represent the one or more commands, a placement or a grouping of the one or more commands, the action to be performed in response to the detection of the invocation of the one or more commands, and implicit and explicit activation rules associated with the one or more commands.

13. The computing device of claim 11, wherein the service provider is one of a software developer associated with the client application, a software developer associated with the host application, and a third party service.

14. The computing device of claim 11, where the abstraction is created by the service provider using one of a manifest template and one or more application programming interfaces (APIs) in response to an installation of the client application on the computing device.

15. The computing device of claim 11 wherein the host application is configured to one of: display the extension as a group on an existing command bar on the user interface, display the extension as one or more groups on a new tab created for the command bar on the user interface based on the one or more definitions, and display the extension on a contextual menu of the user interface.

16. The computing device of claim 15, wherein the host application is further configured to display the extension as the group at a furthest right position on an existing tab relative to other groups on the existing tab of the command bar.

17. The computing device of claim 15, wherein the host application is further configured to display the extension as the group at a position interspersed with other groups on an existing tab of the command bar based on a priority of the extension.

18. The computing device of claim 15, wherein the host application is further configured to display another extension through the user interface of the host application, wherein the extension and the other extension are displayed on an existing tab in an order in which respective client applications associated with extension and the other extension were installed on the computing device.

19. A computer-readable memory device with instructions stored thereon o implement cross-platform command extensibility, the instructions comprising:
receiving at a host application an abstraction for one or more commands associated with a client application, wherein the abstraction comprises one or more definitions, and is an extension with a same package and code such that the extension is enabled across a plurality of platforms, devices, and applications;
displaying the extension through a user interface of the host application based on the one or more definitions;
displaying the one or more commands in conjunction with the extension by translating the one or more commands to one or more graphical control elements based on the one or more definitions; and
in response to detecting a user invoke the one or more commands through the user interface, performing an action based on the one or more definitions.

20. The computer-readable memory device of claim 19, wherein the instructions further comprise:
in response to detecting an error while the action is being performed, notifying the user of the error through the user interface.
